(19) United States
(12) Patent Application Publication
(10) Pub. No.: US 2019/0094369 A1
(43) Pub. Date: Mar. 28, 2019

(54) LiDAR ASSISTED TRAIL ASSESSMENT

(71) Applicant: Matthew A. Woodson, Cave Creek, AZ (US)

(72) Inventor: Matthew A. Woodson, Cave Creek, AZ (US)

(21) Appl. No.: 16/143,039

(22) Filed: Sep. 26, 2018

Related U.S. Application Data
(60) Provisional application No. 62/563,902, filed on Sep. 27, 2017.

(51) Int. Cl. G01S 17/89; G06Q 10/00; G06Q 30/00; G01S 17/02; G01S 7/481

(52) U.S. Cl. CPC G01S 17/89; G06Q 10/20; G01S 7/4813; G01S 17/023; G06Q 30/018

(57) ABSTRACT

A method of standardizing assessment of the condition of a trail for pedestrian, biking, or equestrian use. Apparatuses include a LiDAR unit and a (e.g., video) camera. Data is stored in a common database, synchronized with respect to time (e.g., date) or location, or a combination. Methods include navigating a trail while collecting data with LIDAR and camera, downloading data to a computer, and assessing the trail, for example, against (e.g., USFS) trail standards. Assessment of trails can be standardized to uniform/consistent trail maintenance/construction standards, build/construction plans can be developed, and trail contract compliance can be evaluated. LiDAR data can accurately identify or predict plant encroachment, out of spec rock and grade, risk assessment, and trail failure (e.g., when a hydrology model is applied). Methods can be used to evaluate where to build a new trail by obtaining data from multiple different proposed trail routes and comparing the proposed routes.

### RELATED PATENT APPLICATIONS

This patent application is a non-provisional patent application of, and claims priority to, U.S. Provisional Patent Application Ser. No. 62563902, LiDAR ASSISTED TRAIL ASSESSMENT, filed on Sep. 27, 2017, and has the same inventor. The contents of this priority provisional patent application are incorporated herein by reference.

### FIELD OF THE INVENTION

Various embodiments of this invention relate to assessment, maintenance, repair, and constructions of trails, for example, for pedestrian, biking, or equestrian use. Many embodiments concern use of LiDAR.

### BACKGROUND OF THE INVENTION

In the past, trails, for example, for pedestrian, biking, or equestrian use, were assessed based on general survey data and by obtaining data manually, for example, by walking existing or new trail corridors. This process, however, required many assumptions and was subject to individual opinions of data obtained. Prior art processes provided rough measurements, for example, with a tape measure and various tools. Data was then typically translated by hand to written data for project contract bidding, work prioritization and assignment of work. Weaknesses of such methods included that the information obtained was inconsistent and needed to be obtained manually by qualified trail assessment technicians. As a result, trained personnel were required at every location where reliable data was obtained. This was labor intensive and required trained and qualified staff. In addition, in many instances, detail and understanding of true trail conditions was lacking or limited. Moreover, numerous paper documents typically needed to be completed by hand. Further, in most cases, measurements were sporadic, for example, averaging 1 measurement per 100′ of trail. Still further, accuracy was limited, data collection was time intensive, and it was expensive to obtain data. Further still, data obtained was typically limited and often resulted in more costly project bids, for instance, for trail construction or improvement. Even further, due to the manual process, there was usually a large margin of error and relatively expert interpretation was required to identify factual data. In the past, data obtained for trail construction or improvement projects was typically limited to a GPS line track, running grade, grade profile, and (e.g., sporadic) tread width. Even further still, observed conditions were subject, to the trail assessors' personal opinions, assumptions, or both.

Further, LiDAR units have been used to measure the shape of the ground, but have not been used, or at least have not been fully utilized, in combination with certain other instrumentation or for trail maintenance and construction. Needs or potential for benefit exist for trail assessment equipment and techniques that collect more data, that are less subjective, that can be implemented by personnel with less skill or experience, that are less expensive, that are more reliable, that require less time, that identify more issues, or a combination thereof, as examples. Room for improvement exists over the prior art in these and other areas that may be apparent to a person of skill in the art having studied this document.

### SUMMARY OF PARTICULAR EMBODIMENTS OF THE INVENTION

This invention provides, among other things, devices, methods, and systems that assess trail conditions. Various embodiments provide, for example, as an object or benefit, that they partially or fully address or satisfy one or more of the needs, potential areas for benefit, or opportunities for improvement described herein, or known, in the art, as examples. Certain embodiments provide, for example, as objects or benefits, for instance, that they are more objective or are not subject to as many assumptions or individual opinions as data obtained and used in the prior art or are more accurate or complete. Objects and potential benefits further include, for many embodiments, that data is less expensive to obtain, is more consistent, does not need to be obtained by trail assessment technicians that are as skilled, trained, or qualified, or a combination thereof. As a result, in many embodiments, labor can be less expensive. In addition, in many instances, detail and understanding of true trail conditions can be significantly improved, paper documents needed to be completed by hand can be minimized, or both. Further, in many cases, measurements are less sporadic, accuracy can be better, data collection can be less time intensive, or a combination thereof. Further still, data obtained can result in less costly project bids, for instance, for trail construction or improvement. Even further, due to automation, there can be a smaller margin of error and relatively expert interpretation is not as critical to identify factual data in many embodiments. Even further still, observed conditions are less subject to the trail assessors' personal opinions, assumptions, or both, in a number of embodiments. Objects or potential for benefit include trail assessment techniques that collect more data, that are less subjective, that can be implemented by personnel with less skill or experience, that are less expensive, that are more reliable, that require less time, that identify more issues, or a combination thereof, as examples.

Specific embodiments include apparatuses and methods, for example, for standardizing assessment of a new trail, to be developed or conditions of an existing trail that is used, for instance, for pedestrian, biking, or equestrian use. Various apparatuses include a LiDAR unit and at least one of: a camera, spectral analyzer, or radar unit, as examples. Data obtained (e.g., from LiDAR and another instrument) is stored, in some embodiments, in a common database or is synchronized with respect to time or location (e.g., georeferencing). Further, in many embodiments, a common power supply, support structure, or front pack (or frontpack), for example, can be included in the apparatus or utilized in a method. Further, many embodiments are not just isolated devices, but rather, are connected to, or in communication with, other devices, such as smart phones and tablet computers, for example, via a computer network.

Various methods include acts such as navigating a trail while collecting data with a LiDAR unit. Many embodiments also include (e.g., simultaneously) collecting data with a camera, spectral analyzer, or radar unit, as examples. Various embodiments further include downloading the data to a computer and (e.g., using the computer and the data) assessing the condition of the trail. Spectral data is used, in some embodiments, to identify a plant species, for example, to predict plant encroachment. Still further, in some embodiments, a hydrology model is used, for example, to predict trail failure or to assess durability of the trail. Further still, methods can (e.g., also or instead) be used to evaluate where to build a new trail, for example, by obtaining data from multiple different proposed trail routes and comparing the proposed routes. Even further, in some embodiments, radar can be used to detect the location of rock, for example, below the soil or trail.

Moreover, in various embodiments, assessment of trails can be standardized, for example, with a protocol for trail assessment. Further, in a number of embodiments, trail construction or maintenance contract compliance can be evaluated, trail maintenance can be planned or evaluated, or a combination thereof. Still further, in some embodiments, trails are constructed, maintained, repaired, assessed, or a combination thereof.

Specific embodiments include various methods of assessing a condition of a trail, for example, that is used for at least one of pedestrian, biking, or equestrian use. In some (e.g., such) embodiments, the method includes at least the acts of: navigating the trail while collecting a first set of data with a LiDAR unit and a second set of data with camera, downloading the first set of data and the second set of data to a computer, assessing the condition of the trail, and producing a report. In a number of embodiments, for example, the computer, the first set of data, and the second set of data are used to measure against a data set of trail standards to assess the condition of the trail and produce a report for the trail. Further, in some embodiments, the report includes a description of work that is needed on the trail and images (e.g., from the second set of data).

In various embodiments, the camera and the LiDAR unit are mounted on a common support structure, the first set of data obtained from the. LiDAR unit and the second set of data obtained from the camera are stored, when obtained, in a common database, or both. Still further, in some embodiments, the first set of data and the second set of data are synchronized with respect to time when obtained, the first set of data and the second set of data are synchronized with respect to georeferenced location when obtained, or both. Further still, some embodiments include using the first set of data to identify vegetation, encroachment of vegetation onto the trail, or both. Even further, some embodiments include, for example, while using the computer, the first set of data, and the second set of data to assess the condition of the trail, applying a hydrology model, for example, to predict trail failure. Even further still, in particular embodiments, the method includes predicting when the trail will fail to meet the data set of trail standards, for instance, using a grade of the trail. In certain embodiments, for instance, the data set of trail standards is set by the United States Forest Service (USFS).

Further, some embodiments include performing the method on multiple different proposed routes for the trail and comparing (e.g., the report for) the multiple different proposed routes to determine which of the multiple different proposed routes is to be used for the (e.g., new) trail. Still further, some embodiments include detecting a location and a size of a rock within a length of a trail corridor, for example, and identifying the location and the size of the rock in the report. Even further, certain embodiments include standardizing assessment of multiple trails, for instance, by performing the method on each of the multiple trails, planning maintenance of the trail (e.g., using the computer, the first set of data, or both), or a combination thereof. Further still, in particular embodiments, the report includes an indication of durability of the trail. Even further still, in some embodiments, the method includes evaluating whether a contract has been complied with, for example, where the contract requires construction or maintenance of the trail. Certain embodiments, for instance, include performing the method before the contract is performed and performing the method again after the contract was (e.g., allegedly) performed. Moreover, in various embodiments, the report includes rock size, running grade, grade profile, tread width, vegetation encroachment, drainage relief intervals, or a combination thereof, as examples.

Still further, some specific embodiments include an apparatus for assessing the condition of a trail, for instance, that is used for at least one of pedestrian, biking, or equestrian use. In some embodiments, for example, the apparatus includes a LiDAR unit, and a camera. Further, in various embodiments, a first set of data obtained from the LiDAR unit and a second set of data obtained from the camera are synchronized, for example, with respect to time, location, or both. Even further, in various embodiments, the apparatus is configured to be carried as a backpack or as a front pack, or both, as examples. Other embodiments are also described herein or would be apparent to a person of ordinary skill in the art having studied this document.

### DETAILED DESCRIPTION OF EXAMPLES OF EMBODIMENTS

This patent application describes, among other things, examples of certain embodiments, and certain aspects thereof. Other embodiments may differ from the particular examples described in detail herein. Various embodiments are or concern devices, apparatuses, machines, and methods in which trail condition is assessed; trail maintenance or construction is planned, performed, or evaluated; LiDAR is used; or a combination thereof.

LiDAR stands for Light Detection and Ranging, and is a sensing method that can be used, for example, to examine the surface of the ground. An example of a LiDAR unit is a REVO unit. Another example is a ROBIN unit. In various embodiments, LiDAR can use a pulsed laser, for example, to measure ranges or distances, for example, to the ground. In many embodiments, data is recorded and provides three-dimensional information about the shape of the surface of a trail or the route for a trail, which can be precise (e.g., accurate to within 2 cm) in comparison with other measurement alternatives. In some embodiments, for example, a LiDAR unit includes a laser, a scanner, and a GPS unit or receiver. LiDAR units can be topographic or bathymetric. Topographic LiDAR can use a near-infrared laser to map the surface, and bathymetric LiDAR can use a water-penetrating green light to (e.g., also) measure topography under water (e.g., streams, puddles, or flooded areas). Various embodiments involve LATA (LiDAR Assisted Trail Assessment).

In many embodiments, an individual walks an existing trail, or one or more proposed new trail corridors, with a LiDAR device or unit and, in some embodiments, does not need special training or qualifications. In a number of embodiments, the individual may have been trained to operate the device or apparatus but does not necessarily need to have trail construction, maintenance, engineering, or assessment experience. In various embodiments, the device or unit captures a field of data, for example, at 100 points per square meter, that may be continuous, comprehensive, exhaustive, precise, or a combination thereof. In some embodiments, the LATA or an algorithm, App, or tool translates the information or data obtained, for instance, into an assessment that may be comprehensive, objective, or both. In some embodiments, the assessment includes (e.g., precise) measurements, (e.g., blanket) GPS locations, visual imagery (e.g., pictures, video, or both), or a combination thereof, as examples. Additionally, in particular embodiments, LATA simulates (e.g., long-term or future) erosion issues and, in certain embodiments, applied hydrology, for example, to identify areas that may need to be addressed, for instance, for maximum or desired sustainability. In some embodiments, data can (e.g., easily) be transferred to a (e.g., desk-top) computer, for example. Various embodiments provide land managers (e.g., land owners), trail construction companies, or both, with a (e.g., complete) picture, for instance, with accurate data points. Many embodiments save time, money, or both.

In many embodiments, data can be obtained by a single individual with a LiDAR unit. In some embodiments, other instrumentation is also included. Further, in many embodiments, no special qualifications are needed. Still further, in various embodiments, data is provided using an algorithm or software, for example, that provides land managers and/or trail construction crews easy-to-read, consistent, factual data or digitally compiled information, for example, on a computer, which can be a desk-top computer or mobile device, as examples. Various embodiments provide precise non-subjective data, projected erosion and watershed data, identification of failure points, or a combination thereof, as examples. Further, certain embodiments provide comprehensive data, for example, including accurate blanket measurements of trail tread and corridor. Still further, some embodiments provide data covering surrounding terrain, for example, an average 40′ radius. In other embodiments, the radius of data collection can be 5, 10, 20, 30, 35, 45, 50, 60, 75, or 100 feet, as other examples.

Various embodiments provide assessment based on (e.g., pre-loaded) trail maintenance or construction specifications, for example, per project. Further, some embodiments provide imagery, for example, with GPS locations, for instance, of items or locations requiring (e.g., more) work or repair. Still further, some embodiments produce imagery or show type or extent, and, in particular embodiments, GPS locations, of vegetation encroachment. Still further, some embodiments evaluate project degradation, soil-migration rates, erosion prone locations, or a combination thereof. Even further, some embodiments evaluate a project's hydrology or water-shed conditions. For example, in particular embodiments, water run-off is simulated, evaluated, or both, and impact on the trail over time is projected. Certain embodiments show effectiveness or identify areas to place drainage relief, for example, to minimize trail water damage.

Various embodiments provide standardized assessment, for example, across different land managers, trail construction companies, or both. Further, many embodiments allow construction companies to accurately bid projects with data obtained from trail assessment and (e.g., pre-loaded) trail maintenance or construction specifications. In many embodiments, the bids are based on assessments that are more consistent or standardized, which makes the bidders more confident in their bids and reduces the tendency to overbid to account for unanticipated site conditions. This can reduce the bids and consequently, the cost for land managers. Further, in a number of embodiments, assessments that are more consistent or standardized reduce the number of claims or contract modifications for differing site conditions. This can also reduce the cost for land managers.

Many embodiments reduce labor, evaluate or confirm completion of work to specifications, or both. Further still, various embodiments provide reporting ease, for example, into a computer rather than, or in addition to, in-field review by land managers. Even further, many embodiments prioritize, or can be used to prioritize, work needs or locations where trail work is needed. Still further, in many embodiments, increased accuracy reduces contract costs or overbidding of projects, for example, to cover un-known or un-seen issues. Even further still, some embodiments can be used to (e.g., quickly and easily) plot signage directional layouts and locations, as another example. Still further, in particular embodiments, multiple assessments (e.g., multi-year assessments) provide (e.g., accurate) erosion data, for example, for long-term maintenance budgeting and planning.

Many embodiments are or include apparatuses for assessing condition of a trail. In a number of embodiments, the trail is used for at least one of pedestrian, biking, or equestrian use. In this context, as used herein, “used” includes a route or trail that is intended to be used for that purpose, for example, once the trail is constructed or improved (e.g., if the route or trail is selected). Further, as used herein, “pedestrian use” can include, but is not limited to, hiking, trail running, backpacking, and accessing, on foot, destinations for other activities. Such destinations and activities can include, for example, rock climbing areas or mountains for technical climbing, canyons for canyoneering, rivers, creeks, or lakes for kayaking, canoeing, paddle boarding, pack rafting, swimming, tubing, fishing, bird watching, or rope swinging, and any such areas or other vistas for photography or sightseeing, as examples. Still further, as used herein, “biking” includes mountain biking, including fat biking. Further still, as used herein, “equestrian use” includes riding or leading horses, mules, donkeys, camels, llamas, goats, yaks, or other pack animals. Other uses of trails include skiing, snow shoeing, and sledding (e.g., dog sledding). In many embodiments, trails are limited to non-motorized use. Further, where embodiments are described herein as being used for at least one of pedestrian, biking, or equestrian use, other embodiments are contemplated where the trail is used just for pedestrian use, just for biking, just for equestrian use, for any combination of two such uses, or for non-motorized use, as examples.

In various embodiments, for example, an apparatus for assessing condition of a trail includes a LiDAR unit and a camera. In some embodiments, the LiDAR unit and the camera are combined into one piece of equipment while in other embodiments, the LiDAR unit and the camera are separate. In many embodiments, for example, a first set of data is obtained from the LiDAR unit and a second set of data is obtained from the camera. Further, in particular embodiments, the first set of data and the second set of data are stored in a common database, for example, within the apparatus. In some embodiments, the database, for instance, is in computer memory, for example, a hard drive (e.g., within the apparatus). In many embodiments, the apparatus includes a processor, memory, and a power supply, among other things.

Further, in many embodiments, the first set of data obtained from the LiDAR unit and the second set of data (e.g., obtained from the camera) are synchronized with respect to time. In some embodiments, the time is stored as a date (e.g., only). In other embodiments, however, time is stored more precisely, for example, in date and hour, minutes, seconds, or fractions of a second, as examples. For example, in a number of embodiments, the two sets of data are stored in a manner that makes it possible, or even easy, to identify data from each set that was obtained at the same time. Still further, since the two sets of data are obtained with the same apparatus, in many embodiments, data from each set that was obtained at the same time was also obtained at the same location, for example, along the trail. Further still, in many embodiments, the first set of data obtained from the LiDAR unit and the second set of data (e.g., obtained from the camera) are synchronized with respect to location. For example, in a number of embodiments, the two sets of data are stored in a manner that makes it possible, or even easy, to identify data from each set that was obtained at the same location. For example, in some embodiments, the data is georeferenced, for instance, with respect to GPS coordinates or latitude and longitude, as examples. Even further, in certain embodiments, the apparatus further includes (or includes instead of the camera) a radar unit, for example, to detect rock or bedrock below the surface of the ground, soil, or trail, as examples.

Further still, in some embodiments, the apparatus includes a spectral analyzer (e.g., in addition to or instead of the camera, or in, combination with the camera, in different embodiments). As used herein, a spectral analyzer is a device that identifies wavelength of light or color, for example. In many embodiments, the wavelength, color, or both, is stored digitally or in a way that, can be identified by a computer, for example. In particular embodiments, an apparatus for assessing condition of a trail (e.g., that is used for at least one of pedestrian, biking, or equestrian use) includes a LiDAR unit and a spectral analyzer. Some such embodiments also include a camera. Even further, in a number of embodiments that include a camera, the camera is a video camera, for example, a GoPro or similar device. In certain embodiments, the camera can shoot video or still pictures, for example, at selectable intervals of time or when operated by the user. In some embodiments where the camera is a video camera, images or still pictures, for example, for a report, are sourced from the video. Even further still, in many embodiments that include a camera, the camera and the LiDAR unit are powered by a common power supply (e.g., a battery or multiple batteries). Moreover, in various embodiments that include a camera, the camera and the LiDAR unit are mounted on a common support structure (e.g., housing, case, or frame).

In some embodiments, the apparatus is configured to be carried as a backpack. As used herein, an apparatus is configured to be carried as a backpack, for example, if the apparatus includes two shoulder straps and a pad or flat or ergonomically-shaped surface designed to comfortably press against one's back when being carried. In other embodiments, the apparatus is configured to be chest mounted or carried as a front pack. As used herein, an apparatus is configured to be carried as a front pack, for example, if the apparatus is configured to be mounted on a person's chest without constantly being held by the person. A front pack may include one or more straps and a pad, or flat or ergonomically shaped surface designed to comfortably press against one's chest when the apparatus is being carried. Some embodiments (e.g., of a backpack or front pack) also include a waist belt. Further, in various embodiments, the apparatus is configured to be carried as a backpack or as a front pack. Further, in various embodiments, the apparatus is configured to be carried as a backpack and the apparatus is configured to be carried as a front pack. In other embodiments, the apparatus has one shoulder strap, is configured to be carried by hand (e.g., in front of the person), or is configured to be mounted on a bicycle, horse, or cart, as other examples. Some embodiments are configured to be carried multiple ways. Further, embodiments that have other instruments may have the other instruments similarly powered, supported, or both.

Still other embodiments include various methods, for example, of performing functions described herein. A number of methods, for example, include at least certain acts. Further, various embodiments include an apparatus or method of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations that are feasible are potential embodiments. Some embodiments may include a subset of elements described herein and various embodiments include additional elements as well.

Further, many acts described herein are performed automatically, for example, using a computer, and can be implemented, for example, with software. For each such act described herein, also contemplated is software, that when executed, performs the act described, controls the performance of the act, or both. Some acts described herein, however, are or can be performed manually, with hardware, or with a combination thereof or in combination with software. Where appropriate, various acts described herein are performed automatically, for example, with a computer, other equipment described herein, other equipment known in the art, or a combination thereof.

Various embodiments include different methods of assessing the condition of a trail, for example, that is used for at least one of pedestrian, biking, or equestrian use. In some embodiments, for example, the method includes at least the acts of navigating (e.g., walking or riding) the trail while collecting a first set of data with a LiDAR unit and a second set of data with camera, downloading the first set of data and the second set of data to a computer, and using the computer, the first set of data, and the second set of data to assess the condition of the trail. In some embodiments, the data is downloaded after traveling to the computer In other embodiments, the data is downloaded as it is collected or later, for example, wirelessly. In particular embodiments, the data is downloaded via Bluetooth, for example, to a mobile phone or tablet computer. Further, in certain embodiments, the data is transmitted via the Internet, for example, through or to one or more servers, via a telephone network, or both. In different embodiments, the “computer” is or includes a desktop computer, a laptop computer, a tablet, a smart phone, a server, or multiple such devices.

Further still, in some embodiments, the data, for example, the first set of data obtained from the LiDAR unit, the second set of data obtained from the camera, or both, are stored, for instance, when obtained, in a common database (e.g., within the apparatus). Even further, in particular embodiments, the data, for example, the first set of data obtained from the LiDAR unit and the second set of data obtained from the camera, are stored in a common database after being downloaded to the computer. Even further still, in some embodiments, the data, for example, the first set of data obtained from the LiDAR unit and the second set of data obtained from the camera, are synchronized with respect to time, for example, when obtained. Moreover, in some embodiments, the data, for example, the first set of data obtained from the LiDAR unit and the second set of data obtained from the camera, are synchronized with respect to location or georeferenced, for example, when obtained, for instance, relative to GPS coordinates. Such conditions may also exist for data obtained from one or more other instruments.

Various methods include using a spectral analyzer. Further, in particular embodiments, the method includes, for example, during the act of navigating the trail, gathering spectral data (e.g., wavelength, color, etc.). Still further, in particular embodiments, a method of assessing condition of a trail (e.g., that is used for at least one of pedestrian, biking, or equestrian use) includes (e.g., at least) navigating the trail, for instance, while collecting a first set of data with a LiDAR unit and gathering a second set of spectral data. Various such embodiments also include downloading the first set of data and the second set of data to a computer, and using the computer, the first set of data, and the second set of data to assess the condition of the trail. Some embodiments include using the spectral data, for example, to identify a vegetation or plant type, species, or variety along the trail, as examples. Further, certain embodiments include using the plant species (e.g., along the trail) to estimate a rate of plant encroachment onto the trail, to determine how often to trim the plant species along the trail, or both. In various embodiments the method includes using the spectral data to determine how often to perform maintenance on the trail.

Some embodiments that include navigating the trail while collecting a first set of data with a LiDAR unit and gathering a second set of spectral data, further include (e.g., while navigating the trail) using a camera, for example, a video camera. Further, in particular embodiments, the method includes storing (e.g., video) footage of the trail taken with the camera. Still further, in certain embodiments, the method at includes powering the camera and the LiDAR unit with a common power supply (e.g., one or more batteries). Even further, in some embodiments, the method includes (e.g., while navigating the trail) supporting the camera and the LiDAR unit on a common support structure (e.g., a backpack or front pack). Even further still, in some embodiments, the method includes (e.g., while using the computer, the first set of data, and the second set of data to assess a condition of the trail), applying a hydrology model, for example, to predict trail failure (e.g., for risk assessment, trail maintenance planning, or both).

Further embodiments include various methods of assessing the condition of a trail (e.g., that is used for at least one of pedestrian, biking, or equestrian use) that includes at least the acts of: navigating the trail while collecting a first set of data with a LiDAR unit, after the navigating, downloading the first set of data to a computer, and using the computer, the first set of data, and at least one hydrology model to assess durability of the trail. Further, in some embodiments, the method includes predicting failure of the trail. Still further, in some embodiments, the method includes (e.g., while using the computer and the first set of data), evaluating durability of the trail from a shape of a rut in the trail, using grade of the trail, or both. Still further, in some embodiments, the method includes (e.g., while using the computer and the first set of data), evaluating durability of the trail from a slope of the trail, soil type, hydrology information for the area, or a combination thereof, as examples.

Even further embodiments include various methods of evaluating where to build a new trail, for example, that is used (i.e., at least after being built) for at least one of pedestrian (e.g., hiking), biking, or equestrian use. In many embodiments, the method includes a combination of the acts that are described herein. In some such embodiments, for example, the act of navigating is performed on multiple different proposed trail routes and the method further includes comparing the multiple different proposed trail routes to determine which of the proposed trail routes is to be used for the new trail. In some embodiments, the proposed trail routes are identified in advance, for example, from a topographical map, satellite imagery, or both. Further, in some embodiments, the LiDAR operator is guided on each of the proposed routes with GPS.

Moreover, various methods include an act of detecting a location of rock below soil, below the ground surface, or below the trail, as examples. For example, some methods of assessing the condition of a trail (e.g., that is used for at least one of pedestrian, biking, or equestrian use) includes (e.g., at least) certain acts that include navigating the trail while collecting a first set of data with a LiDAR unit and a second set of data with radar. Some such embodiments further include, for instance, downloading the first set of data and the second set of data to a computer, using the computer, the first set of data, and the second set of data to assess a condition of the trail, or both. For another example, some methods of assessing the condition of a trail (e.g., that is used as described herein) includes (e.g., at least) the act of navigating the trail while collecting a first set of data with a LiDAR unit and a second set of data indicating a location of rock below the trail. In different embodiments, the second set of data can be collected with radar, for example, ground penetrating radar (GPR), or with another instrument capable of seeing below the ground surface. Further, where embodiments are described herein that use radar, other embodiments are contemplated that use another sensing system or both radar and another sensing system.

Many embodiments that include collecting data that indicates a location of rock further include downloading the data (e.g., the first set of data and the second set of data) to a computer, using the computer (e.g., and the data, for instance, the first set of data and the second set of data) to assess a condition of the trail, or both, for instance. Further, in a number of embodiments, that include evaluating the location of rock, the rock is bedrock. Still further, in many embodiments that include measuring location of rock, depth of the rock (i.e., below the surface) is what is determined. Even further, in various embodiments that include location of rock, the location of the rock is detected along a length of the trail, for example, the entire length of the trail, or along the length of certain segments of the trail, for instance, where erosion is considered to be particularly problematic or critical. Even further still, in many embodiments that include location of rock, the location of the rock is detected using a radar unit, for example GPR.

Further embodiments include various methods of standardizing the assessment of trails, methods of predicting the durability of trails, methods of predicting the failure of trails, methods of planning maintenance of (e.g., one or more) trails, and protocols for the assessment of trails, for example, that include various combinations of acts described herein. Still other embodiments include various methods of evaluating where a trail should be built, for instance, that include various combinations of acts described herein. Even further embodiments include various methods of testing a prediction concerning a trail (e.g., concerning a rate or pattern of degradation) In some such embodiments, for example, the method includes repeating a combination of acts described herein over time and evaluating changes in the trail over time. Different combinations of the acts described herein are different embodiments. In various embodiments, data can be used as baseline data, to identify major conditions or issues, to locate areas that need rehabilitation, to prescribe solutions, to prepare contracts or contact documentation, to verify contract compliance, or a combination thereof.

Information that is gathered or derived from data that is collected can include, in various embodiments, tread conditions, vegetation encroachment, drainage relief intervals, soil migration rates, longitudinal grade profile, side slope grade, tread cross slope grade, elevation, cross sections, signage, contract documentation, and post-work verification. In some embodiments, data can have an accuracy of 2 cm, for example. Further, in various embodiments, data can be used to document conditions, monitor changes, prioritize maintenance or construction, budget for maintenance or construction, georeference signs, bridges, and features, check compliance with design standards, create a trail difficulty rating, provide location information for rescues, or a combination thereof.

Even further still, other embodiments include various methods of evaluating whether a trail contract has been complied with. Such methods can be used, for example, when the contract includes construction, repair, or maintenance of a trail. In some embodiments, for example, the method includes evaluating whether a contract has been complied with (e.g., where the contract requires construction or maintenance of the trail). Certain embodiments, for example, include performing the method before the contract is performed and performing the method again after the contract has (e.g., allegedly) been performed. In some such embodiments, for example, the method includes performing a first set of the acts described herein after the contract is alleged to have been performed. Again, different combinations of the acts described herein represent different embodiments. Further, in some such embodiments, the method includes (e.g., also) performing the first set of the acts before the contract was performed. In some embodiments, the method further includes comparing data collected when performing the first set of acts before the contract was performed with data collected when performing the first set of acts after the contract was (e.g., alleged) to have been performed. Still further, some embodiments include various methods of constructing a trail, maintaining a trail, repairing a trail, or a combination thereof, for example, the method including a combination of the acts described herein or a method described herein.

In various embodiments, the method includes acts of navigating the trail while collecting a first set of data with a LiDAR unit and a second set of data with camera, downloading the first set of data and the second set of data to a computer, assessing the condition of the trail, and producing a report. Various embodiments include standardizing assessment of a new trail to be developed or conditions of an existing trail, as examples. In some embodiments, for example, the computer, the first set of data, and the second set of data are used to measure against a data set of trail standards to assess the condition of the trail, produce a report for the trail, or both. A trail standard may be produced by a land manager or land owner, as examples, or may be an industry standard, for instance, used by land managers, trail construction and maintenance contractors or companies, or both. Trail standards may include, for example, acceptable grade, width, clearing limits of vegetation, etc., for trails. Other aspects of trails are described herein that may be part of a trail standard. Further, in some embodiments, the report includes a description of work that is needed on the trail (e.g., to make the trail meet the trail standards or to maintain or construct the trail) and images (e.g., from the second set of data, for instance, still photographs of the trail, path for the trail, vegetation, etc.). In some embodiments, the report is printed on paper for distribution (e.g., for decision making, bids, etc.). Still further, in some embodiments, the report is distributed electronically, or a link is provided to the report. Even further, in some electronic embodiments, the report includes video, audio, or both (e.g., from the second set of data). Moreover, as used herein, the term “images” includes still pictures, video, or both. Even further still, in some embodiments, the report includes a map of the trail, for example, with mileage markers, grade, elevations, etc. Furthermore, in various embodiments, the report includes rock size, running grade, grade profile, tread width, vegetation encroachment, drainage relief intervals, or a combination thereof, as examples.

Further, some embodiments include (e.g., while using the computer, the first set of data, the second set of data, or a combination thereof, for instance, to assess the condition of the trail), applying a hydrology model to predict trail failure. Even further, in particular embodiments, the method includes predicting when the trail will fail to meet the data set of trail standards (e.g., set by the United States Forest Service (USES)), for instance, using a grade of the trail. Further still, some embodiments include performing the method on multiple different proposed routes for the trail and comparing (e.g., the report for) the multiple different proposed routes, for instance, to determine which of the multiple different proposed routes is to be used for the (e.g., new) trail. In different embodiments or situations, the condition of the trail may be in one or more of different states when the method is performed. These states may range from essentially no trail at all (e.g., simply a proposed route for a trail), to an existing trail that may be in any of a range of conditions, for instance, with respect to the trail standards. As used herein, the word “trail” includes a route or path that is being considered or evaluated for possible construction of a new trail.

Still further, some embodiments include detecting a location and a size of a rock (e.g., in or adjacent to the trail), for instance, along a length of the trail. Further, some embodiments, include, for example, identifying the location and/or size of the rock (e.g., in the report). Further, some embodiments include detecting a location and a size of a rock within a length of a trail corridor, identifying the location and the size of the rock in the report, or both. Even further, certain embodiments include standardizing assessment of multiple trails, for instance, by performing the method on each of the multiple trails. Moreover, certain embodiments include planning maintenance of the trail for example, using the computer, the first set of data, or both. In certain embodiments, the second set of data is also used. Further still, in particular embodiments, the report includes an indication of sustainability or durability of the trail, for example, predicting how the trail will hold up over time, how much maintenance will be required to maintain the trail standards, or both.

Further, various embodiments of the subject matter described herein include various combinations of the acts, structure, components, and features described herein, shown in any drawings, described in any documents that are incorporated by reference herein, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A method of standardizing assessment of a new trail to be developed or conditions of an existing trail that is used for at least one of pedestrian, biking, or equestrian use, the method comprising at least the acts of:
navigating the trail while collecting a first set of data with a LiDAR unit and a second set of data with camera;
downloading the first set of data and the second set of data to a computer;
using the computer, the first set of data, and the second set of data to measure against a data set of trail standards to assess a condition of the trail and produce a report for the trail wherein the report comprises a description of work that is needed on the trail and images from the second set of data.

2. The apparatus of claim 1 wherein the camera and the LiDAR unit are mounted on a common support structure.

3. The method of claim 1 wherein the first set of data obtained from the LiDAR unit and the second set of data obtained from the camera are stored, when obtained, in a common database.

4. The method of claim 1 wherein the first set of data and the second set of data are synchronized with respect to time when obtained.

5. The method of claim 1 wherein the first set of data and the second set of data are synchronized with respect to georeferenced location when obtained.

6. The method of claim 1 further comprising using the first set of data to identify vegetation and encroachment of the vegetation onto the trail.

7. The method of claim 1 further comprising, while using the computer, the first set of data, and the second set of data to assess the condition of the trail, applying a hydrology model to predict trail failure.

8. The method of claim 1 further comprising predicting when the trail will fail to meet the data set of trail standards wherein the data set of trail standards is set by the United States Forest Service (USFS).

9. The method of claim 8 wherein the predicting when the trail will fail comprises using a grade of the trail.

10. The method of claim 1 further comprising performing the method on multiple different proposed routes for the trail and comparing the report for the multiple different proposed routes to determine which of the multiple different proposed routes is to be used for the trail.

11. The method of claim 1 further comprising detecting a location and a size of a rock within a length of a trail corridor and identifying, the location and the size of the rock in the report.

12. The method of claim 1 further comprising standardizing assessment of multiple trails by performing the method on each of the multiple trails.

13. The method of claim 1 wherein the report includes an indication of durability of the trail.

14. The method of claim 1 further comprising planning maintenance of the trail using the computer and the first set of data.

15. The method of claim 1 further comprising: evaluating whether a contract has been complied with, the contract requiring construction or maintenance of the trail; including performing the method before the contract is performed; and
performing the method after the contract has allegedly been performed.

16. The method of claim 1 wherein the report includes:
rock size;
running grade;
grade profile;
tread width;
vegetation encroachment; and
drainage relief intervals.

17. An apparatus for assessing condition of a trail that is used for at least one of pedestrian, biking, or equestrian use, the apparatus comprising:
a LiDAR unit; and
a camera;
wherein a first set of data obtained from the LiDAR unit and a second set of data obtained from the camera are synchronized with respect to time.

18. The apparatus of claim 17 wherein the apparatus is configured to be carried as a backpack or a front pack.

19. An apparatus for assessing condition of a trail that is used for at least one of pedestrian, biking, or equestrian use, the apparatus comprising:
a LiDAR unit; and
a camera;
wherein a first set of data obtained from the LiDAR unit and a second set of data obtained from the camera are synchronized with respect to location.

20. The apparatus of claim 19 wherein the apparatus is configured to be carried as a backpack or a front pack.
